(19) United States
(12) Patent Application Publication
(10) Pub. No.: US 2005/0213315 A1
(43) Pub. Date: Sep. 29, 2005

(54) Positional responsive illuminated hand device and system

(76) Inventor: Richard D. Jones, Venice, FL (US)

Correspondence Address: James D. Haynes, Suite 7C, 10225 Ulmerton Rd., Largo, FL, 33771, US

(21) Appl. No.: 10/883,190

(22) Filed: Jul. 2, 2004

Related U.S. Application Data
(63) Continuation-in-part of application No. 10/810,423, filed on Mar. 29, 2004.

(51) Int. Cl. F21V 21/08

(52) U.S. Cl. 362/103

(57) ABSTRACT

An Illumination device for mounting on the hand of the user wherein the hand illumination means includes an internal positionally responsive switching means connected to a power source to cause the illumination means to be energized in a selectable manner when the hand device is in a predetermined position and de-energized when the hand device is in another predetermined position and may also contain there within a further switching means for causing a transmitter to signal a remote receiver to thus control a further illumination device for ultimate use in traffic control, school crossings and other motorist or pedestrian directional needs.

The present application is a continuation-in-part of my co-pending application Ser. No. 10/810,423, filed Mar. 29, 2004.

### BACKGROUND OF THE INVENTION

1. Field of the Invention

This invention relates to portable lighting devices, and more particularly, to palm-mounted traffic control signals such as may be used by school guards, road construction crews and other persons in situations where there is a need for signals which are positional or conditionally responsive to direct the actions of individuals. The user of the present invention may direct traffic or individuals with a lighted means that is energized in response to the position of the user's hand while the user's hands are not occupied by holding and maintaining a sign, signaling means, or flashlight.

2. Description of the Prior Art

Police officers, school crossing guards and other individuals engaged in the orderly and safe flow of vehicular and pedestrian traffic face a multitude of situations that pose threats to their well-being and to the well-being of individuals who simply do not see them due to darkness or other instances of inadequate lighting or the complexity of traffic. While flashlights and lighted signs do help in this regard, they must be held in the user's hand, thus making the hand unavailable for other tasks such as directing traffic, using commination means and the like. Traffic safety is a growing concern throughout the world. Each year, more and more people are being injured and/or fatally wounded due to accidents. Traffic control devices range in complexity from simple placard-type signs to combination electric signal lights and vehicle sensors. The development and use of this variety of display devices is not just to control the flow of traffic, but also to advise of hazardous road conditions such as curves, construction, road icing, school crossings, pedestrian directions and the like. Many accidents are caused because one inadvertently fails to read and/or identify traffic warning signs. Many individuals are so preoccupied by activities about them that they fail to see warning signs. Our environment is saturated with signs and signals which are not recognized by the person(s) who may be endangered.

Innovations in this area continue to be motivated to provide condition responsive traffic control devices. Typical examples of such devices include variable timer circuits present to control signal light cycling intervals according to expected rush-hour and non-rush-hour traffic volume and embedded road surface vehicle sensors for initiating a signal light cycle. Generally, the condition responsive control devices respond to an unplanned change in the condition of the environment, such as a power outage, flooding, freezing temperature or the like. Speciality traffic control devices have been developed to try to address the problem of certain unplanned changes in the environment which affect the orderly flow of traffic or represent potential hazards.

Hand traffic control signs and devices are well known. A large number of these consist of devices which must be held in the user's hand. These have served a useful purpose in the past and have been widely used. However, some of these are not as easily seen in inclimate weather, darkness, twilight or dusk as desired. Various devices have been suggested none of which are lighted in response to the position of the user's hand and which may initiate control signals to other devices in combination therewith to enhance safety. Some devices have taken the form of gloves that must be worn by the user and controlled by a manual switch.

Motor vehicle drivers' habits and driving awareness vary, depending on a series of obstacles in driving proficiency. Some examples are: the posted speed limit, number of travel lanes, the driver behind scenes, the sun just rising or setting creating a glare in visibility, the driver is reading or writing while he/she drives, the driver is using a cell phone, the driver is disciplining children, the volume of their stereo set high, and the obstructions on roadways. The short list of examples above reflect only a partial list of why commanding the motorist's attention on what is going on outside the vehicle, and on the roadway is becoming increasingly more and more difficult.

Flashing lights have been used for decades to gain motorist awareness from simple businesses displaying these signs or traffic signs themselves. Simple flashing of signs no longer gains the motorist attention due to the partial list of examples above. We have incorporated into our device, light emitting diodes, hereinafter referred to as “LED”, in self contained clusters of LEDs in an optical exact light output magnification refection which creates a brilliant light output. Built into this cluster LED lighting device are multiple flashing sequences and even a “steady” burn cycle of different colors, all for gaining and demanding the motorist complete attention while traveling the roadway to thus provide the user with the usefulness of a flashlight without the burden of holding it.

A second, self enclosed set of LED lights in an identical maximum optically correct light, can be supplied for roadway situations for increased intensity or for different colors. The LEDs may be programmed to work identically or work in an alternating, flashing sequence as well as multiple settings of flash cycles or variations of lighting intensity.

Accordingly, an object of the present invention is to provide an illuminated hand signal (device) which may be attached to the user's hand to provide a device that is highly visible to an approaching motorist or pedestrian while leaving the user's hand free for use without needing to hold a light, a sign or other devices for directing vehicular traffic or pedestrian traffic.

Another object of the invention is to provide a hand mountable light which is lightweight and easy maintained for extended periods of time.

Still another object of the intention is to provide an illuminated hand signal that is effective to flash or be lighted only when the user desires to effect a viewer's recognition and response and/or to remotely control other signals responsive to the same user reaction and control.

Still another object of this invention is to provide lighting that is selectively configured to simply light, flash, flash in a pre-determined sequence and/or colors for a desired display.

Yet another object of the present invention is to provide a portable, illuminated hand mountable device that includes circuitry to cause a signal to be transmitted to a remote signaling device which operates in unison or a predetermined sequence with the illuminated hand device.

A further object of the present invention is to provide illumination means comprised of light emitting diodes (LEDs) which are programmable to flash in a predetermined sequence and/or colors.

### BRIEF SUMMARY OF THE INVENTION

The above objects are achieved with a portable illuminated hand mountable device wherein the illuminated hand device utilizes a positional sensitive switch to activate lights to cause superior recognition of the user thereof and in inclimate conditions as well as being interactive with a remote sign for selective control thereof.

The illuminated hand signal includes means for securing the illumination means onto the palm or back of one's hand whereby the lighting means is energized by the position of the user's hand by positionally sensitive switching means therein for voluntary control of the lighting effect of the illuminated hand signal. In an alternate embodiment the illuminated hand signal embodies switching means for activating a signaling means for control of a remote lighting means for further indication to viewers of a desired message.

In a preferred embodiment, the illuminated hand signal houses a switch which is positional sensitive to cause the lighting means to be lighted when held in a preferred position and extinguished otherwise to thus permit the user to voluntarily determine when to optimize recognition.

The hand device may also include a transmitter which is energized when the illumination means is energized to transmit a signal to a remote receiver for thus energizing a lighting means at a remote location. When the hand device is positionally changed to cause the illumination means (lights) to be extinguished, a signal is then transmitted to the received at a remote location to turn off the illumination means at the remote location.

### BRIEF DESCRIPTION OF THE DRAWINGS

FIG. 1 is a perspective view showing a front side and a right side of the illuminated hand device according to a preferred embodiment of the present invention.

FIG. 2 is a right side view of a preferred embodiment of the illuminated hand device.

FIG. 3 is a left side view of FIG. 1 with strap 9 in a secured position.

FIG. 4A is a back view of hand device 2 according to a preferred embodiment of the present invention.

FIG. 4B is a perspective view of hand device 2 showing the right side and back side of the illuminated hand device according to a preferred embodiment of the present invention.

FIG. 5 is a perspective view of an illuminated hand device disclosing a power source attached to the illuminated hand device for illumination of the lighting effects.

FIG. 7 discloses a preferred embodiment schematic diagram of illuminated hand device 2, in combination with a remote illumination means 19 and related apparatus such as a power source 30, a controller 17, and lighting means 14 and lighting means 16.

FIG. 8 discloses a remote illumination means on a traffic cone remote to the hand device.

FIG. 9 is a perspective view of the illumination means of FIG. 8.

FIG. 10 is a side view of FIG. 9 wherein the front side, the back side, the right side, the left side and the top side are identical as visually perceived.

FIG. 11 discloses a schematic diagram of illuminated hand device 2 in combination with a remote illumination means similar to that disclosed in FIG. 7 which embodies arrays of light emitting diodes.

FIG. 12 discloses an alternative embodiment of the present invention wherein the remote illumination device is a traffic cone with illumination means.

### DETAILED DESCRIPTION OF THE INVENTION

Referring now to the drawings, the details of preferred embodiments of the present invention are graphically and schematically illustrated. Like elements in the drawings will be represented by like numbers.

The present invention provides an illuminated hand signal which may be secured to the hand of the user thus leaving the hand of the user without the burden of holding it. The invention also includes a combinational use of the illuminated hand signal in combination with a remote light fixture to further implement cautionary alert of viewers.

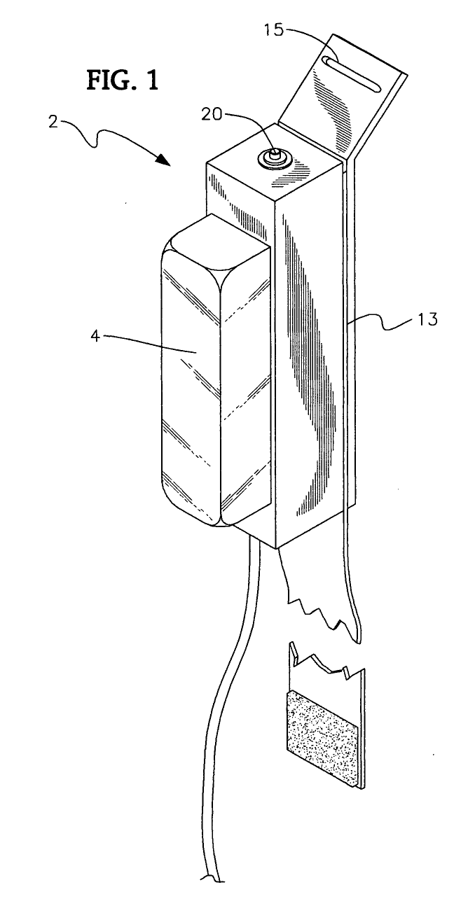

Referring to FIG. 1, hand device 2 has lighting means 4 and a bottom substrate 13 which has a strap 11 secured between substrate 7 and the bottom 13 of lighting means 4. Substrate 13 has a flange 8 which slopes away from lighting means 4 and has an aperture 15 within the flange 8. Aperture 15 is dimensioned to receive there through an end of strap 11. Strap 11 is secured between substrate 7 and bottom 13 of lighting means 4.

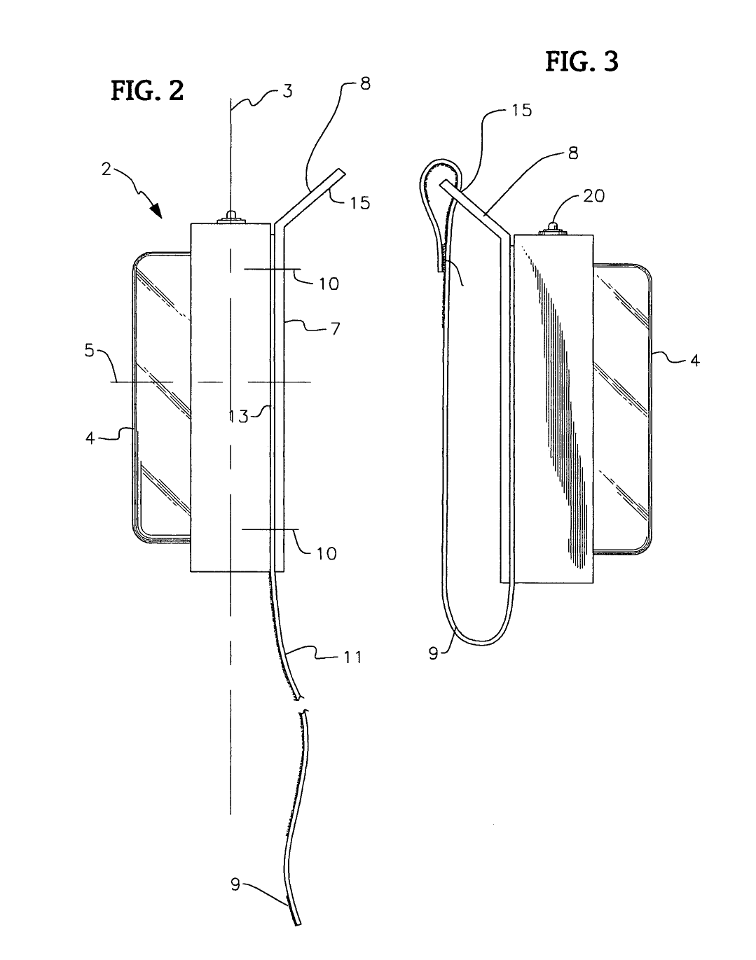

Strap 11 is of sufficient length to extend from lighting means 4 and wrap around a persons hand and feed through aperture 15 of flange 8 and turn back upon itself and attach to itself by use of a self attachment means such as Velcro® as more particularly disclosed in FIG. 2. A first side 17 of strap 11 has a surface such as Velcro® for securing a portion 17 of strap 11 to itself in a disengaging mating relationship.

Flange 8 is designed to have a shape that will generally conform to the portion of the human hand between the index finger and the thumb thereof. Strap 11 extends around the ulmar portion of the human hand between the wrist and the little finger of the human hand. Flange 15 is useful in maintaining the lighting means in a predetermined position over the palm of the user. It is understood that a lighting means may also be positioned on the back of the hand of the user in a similar manner.

FIG. 2 discloses a left side view of a preferred embodiment of the present invention. Strap 11 is caused to wrap around the hand of the user and pass through aperture 15 of flange 8 and bend back over itself and attach to itself to secure the illumination means to the hand and over the palm of the user.

FIG. 3 is a bottom view of the present invention. Substrate 7 is removably secured to bottom 13 of lighting means 4 by attachment means such as screws 7a. Strap 11 is positioned between bottom 13 and substrate 7 and secured there between by screw 7a which join bottom 13 and substrate together. This permits the user of the present invention to replace the strap as and when desired to provide a particular color or dimension of the strap as desired by the user.

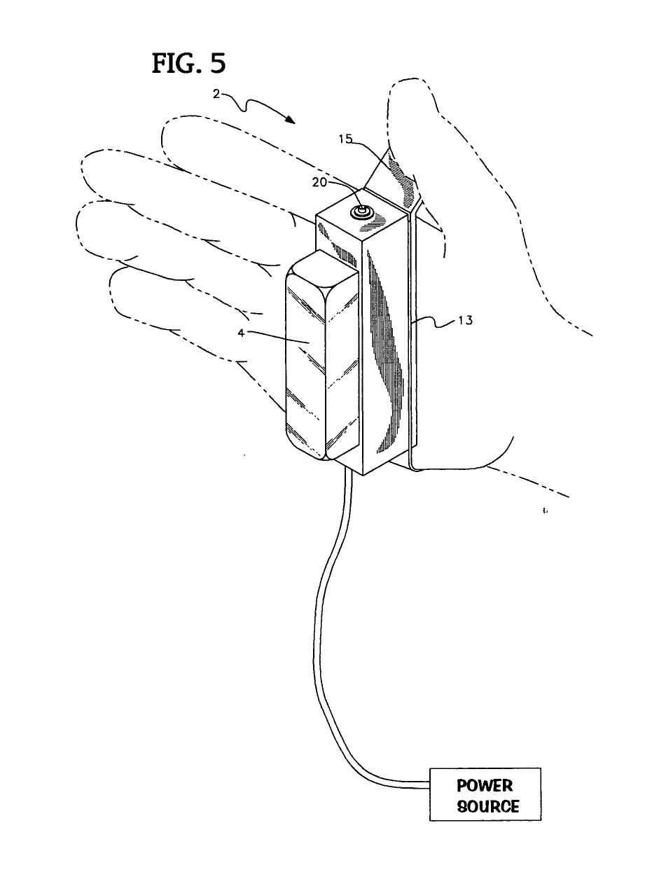

Illuminated hand signal device 2 is further disclosed in FIG. 5 as being selectively connected to power source 12 which supplies the power to cause the illumination means 4 to be selectively illuminated. Power source 12 may be a remote power source which will supply significant power to energize lighting means having intense illumination for improved recognition by traffic or pedestrian.

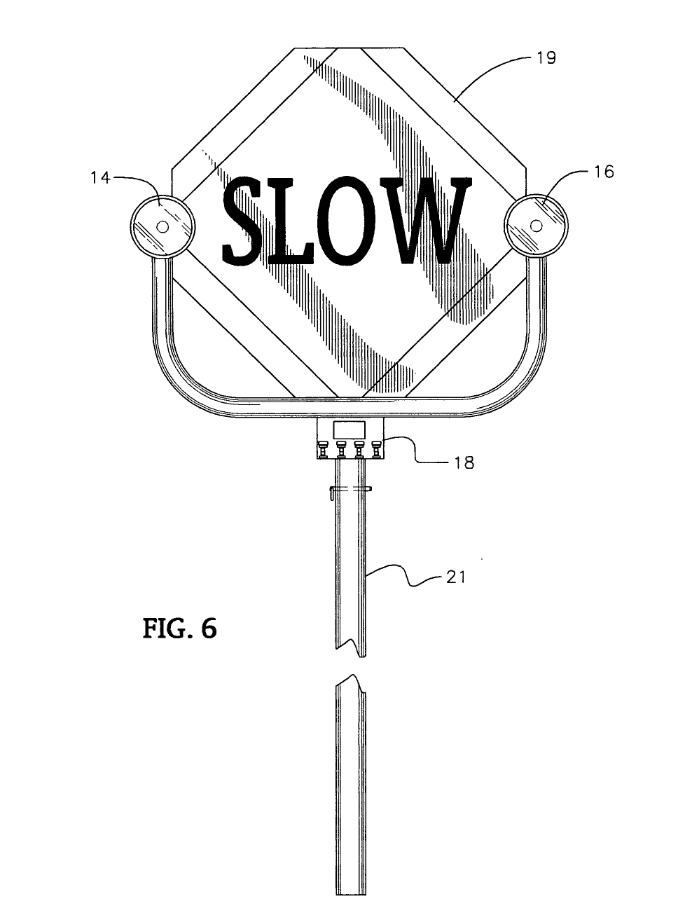

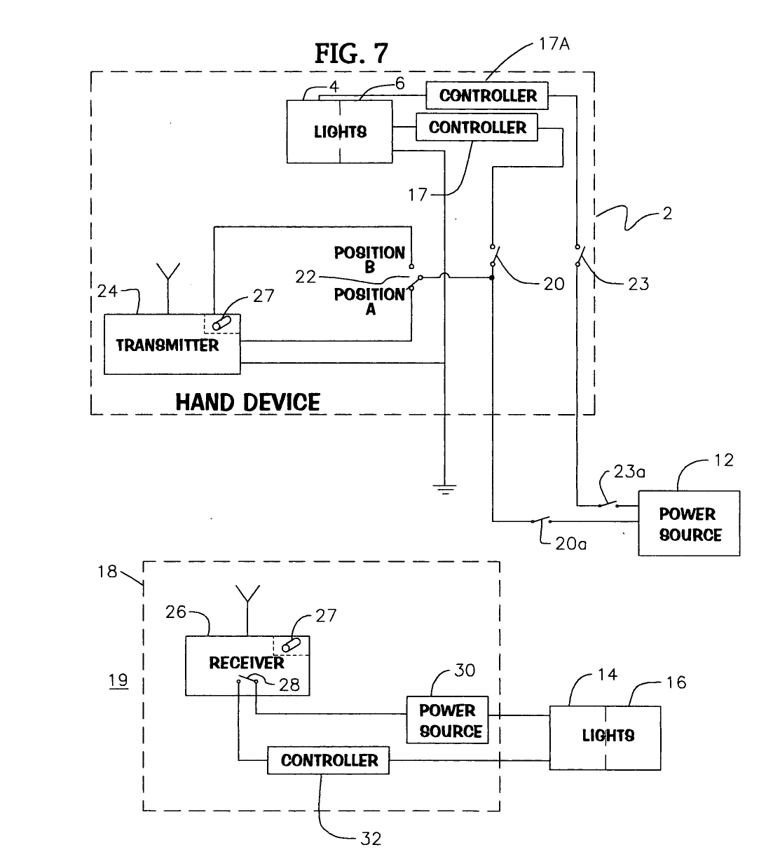

Hand illumination device 2 may be used to control a sign or illumination device 19 (FIG. 6) that is remote to hand device 2. Illumination device 19 comprises illumination means 14 and illumination means 16 which are responsive to a control system housed in structure 18. The entire structure is supported on a vertical member 21. The details of the control system in structure 18 are disclosed in FIG. 7 to include a receiver 26 with an internal switch 28, a power source 30 for energizing lighting means 14 and lighting means 16.

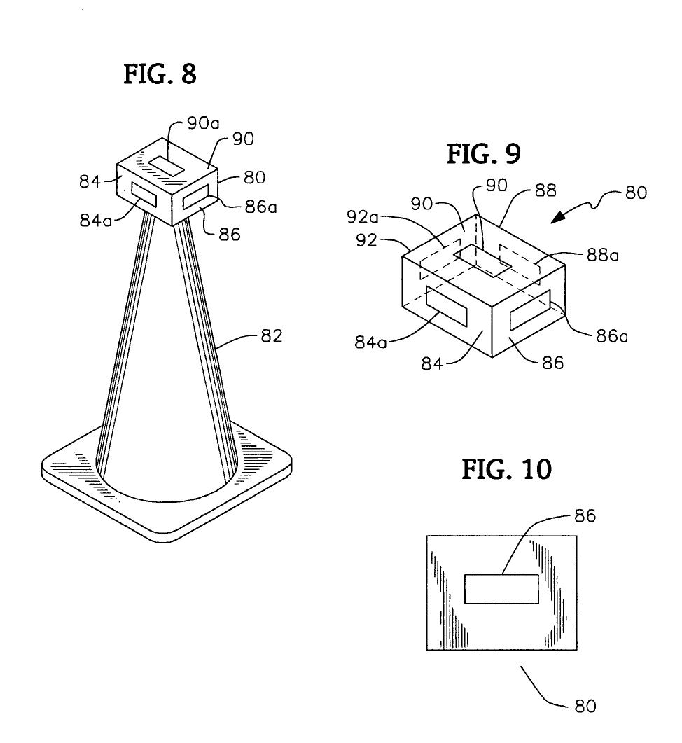

FIG. 8 represents a traffic cone which has mounted thereon an illumination means 80 which has mounted thereon various arrays of lighting means 84a, 86a, 88a, 90a and 92a.

A schematic of the electrical connections of hand illumination device 2 and remote illumination device 19 are shown in FIG. 7. Hand illumination device 2 comprises a first switching means 20 which is positionally responsive to cause switch 20 to be in a closed position when hand device 2 is caused to be in a predetermined posture. When switch 20 is closed, lighting means 4 is energized. Hand illumination device 2 comprises a second switching means 23 which is positionally responsive to cause switch 23 to be in a closed position when hand device 2 is caused to be in a predetermined posture. When switch 23 is closed and lighting means 6 is energized. When the position of hand device 2 is changed, switch 20 and switch 23 will open to thus cause lighting means 4 and lighting means 6 to be extinguished (the electric current source 12 is disconnected from said illumination means 4).

Controller 17 may be connected between power source 12 and lighting means 4 to thereby control the particular lighting sequence of lighting means 4. Controller 17a may be connected between power source 12 and lighting means 6 to thereby control the particular lighting sequence of lighting means 4. Controller 17 and controller 17a are responsive to short on-off pulses to thereby cause the pulsing sequence of lighting means 4 and lighting means 6 to vary. Lighting means 4 and lighting means 6 may comprise a plurality of light emitting diodes each of which is responsive to its respective controller to be energized in a predetermined sequence and for predetermined durations. Since switch 20 and switch 23 are positionally sensitive to the position of the illuminated hand device, the user may simply cause device 4 to be quickly modulated between positions to thus cause the controllers 17 and 17a to change modes to cause a change in the illumination sequence and duration. Whelen® Engineering Company, Inc. is a manufacturer of such lighting means as may be adapted for use in this preferred embodiment.

Additionally, power source 12 may be connected and disconnected to lighting means 4 by way of switch 23a and power source 12 may be connected and disconnected to lighting means 6 by way of switch 20a. Use of switches 23a and 20a may cause hand device 2 to be non-responsive to any position of device 2. Switch 23a and switch 20a may function simply as an on-off switch. Switch 23a may be simply turned on to enable the features of the illuminated hand device or may be pulsed on and off while the power source is electrically connected to lighting means 4 to thus cause controller 17a to change the flashing sequence and/or duration of lighting means 4.

Switch 20 and switch 23 are positionally sensitive switches, that is, when the illuminated hand device 2 is in a first position relative to the surface of the earth, the switch is closed. When the illuminated hand device 2 is in a second position relative to the surface of the earth, the switch is open. When illuminated hand device 2 is mounted on the hand of the user, the hand device 2 will have a vertical axis 3 in general alignment with strap 12 and longitudinal axis 5 in general alignment with the fingers of the hand. See, FIG. 1.

As the user of the illumination hand device 2 raises his or her hand such that the fingers are point upwardly, switch 20 and switch 23 are closed. As the hand of the user lowers his or her hand below a position where the forearm of the user is parallel with the earth, switch 23 will open to thus cause illumination hand device 2 to be de-energized.

Switching means 22 is positionally responsive in the same manner as switching means 20 and switching means 23 when both lighting means 4 and lighting means 6 are utilized. When switching means 20 is open, switching means 22 is in position A. When switching means 20 is closed, switching means 22 is in position B. Switching means 20 and switching means 22 are positioned to respond to the position of the illuminated hand device 2 in like manner.

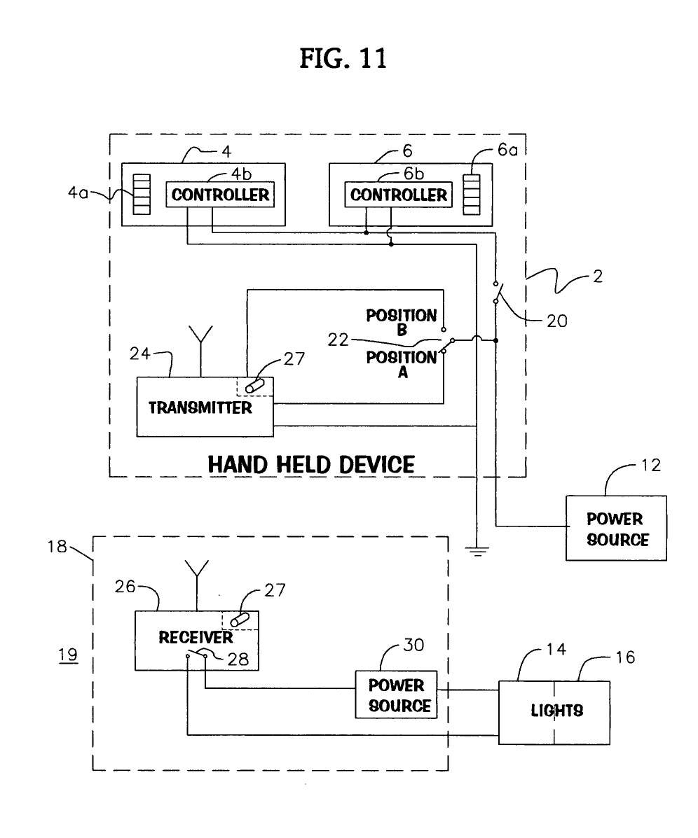

Referring to FIG. 7 and FIG. 11, the purpose of switching means 22 is to activate transmitter 24 which is a transmitter readily available in the art which transmits a signal to be received by state-of-the art receiver 26 to cause switching means 28 to be closed to thus cause illumination means 14 and illumination means 16 to be energized by power source 30. In this manner, remote illumination device 19 is energized in sequence with hand held device 2. Transmitter 24 and receiver 26 are state-of-the-art devices which inherently may include an internal power source for powering the transmitter 27 and/or the receiver 26.

When illuminated hand device 2 is positioned to cause the lighting means 4 thereon to be extinguished (switch 20 is open) and switch 22 is position A, the transmitter is thus caused to emit a signal which signal is received by receiver 26 to cause switch 28 to open to extinguish illumination means (lights) 14 and illumination means 16.

Controller 32, FIG. 7 of remote illumination device 19 may be selectively connected between power source 30 and lighting means 14 and lighting means 16 to thus cause lighting means 14 and lighting means 16 to pulsate or be illuminated in a predetermined manner for best viewer recognition.

As further disclosed in FIG. 7, a switch 23a may be interposed between positional sensitive switch 23 and power source 12 to connect and disconnect power source 12 from hand device 2. Additionally, a switch 20a may be interposed between positional sensitive switch 20 and power source 12 to connect and disconnect power source 12 from hand device 2. Switch 23a and switch 20a may be conformed into a double pole switch so that their position is always the same. The user may pulse switch 23a quickly on and off to cause controller 17a to receive rapid pulses of power. Controller 17a will respond to the rapid pulse or pulses to change the programming of controller 17a. This will effect the sequencing of the flashing of light 4, the rapidity of flashing of light 4, or cause light 4 to continuously be lighted.

The user may pulse switch 20a quickly on and off to cause controller 17 to receive rapid pulses of power. Controller 17 will respond to the rapid pulse or pulses to change the programming of controller 17. This will effect the sequencing of the flashing of light 6, the rapidity of flashing of light 6, or cause light 6 to continuously be lighted.

The same result may be achieved by the user quickly moving the position of hand device 2 to cause positional sensitive switch 20 and positional sensitive switch 23 to open and close which will cause their respective controller 17 and controller 17a, respectively, to effect the sequencing of the flashing of light 6 and light 4, respectively.

Controller 4b and controller 6b (FIG. 11) and controller 17a and controller 17 (FIG. 7) may also cause various colors of light to be emitted from their respective LED (light emitting diode) arrays. Lighting means 4 may be of a predetermined color as well as lighting means 6 (FIG. 7 and FIG. 11) to permit the user of hand device 2 to convey a particular signal (message) to the individual for whom the light is intended. Yellow may mean “caution”, red may mean “stop” and green may mean “go”. Other colors may be used as determined by the user of hand device 2.

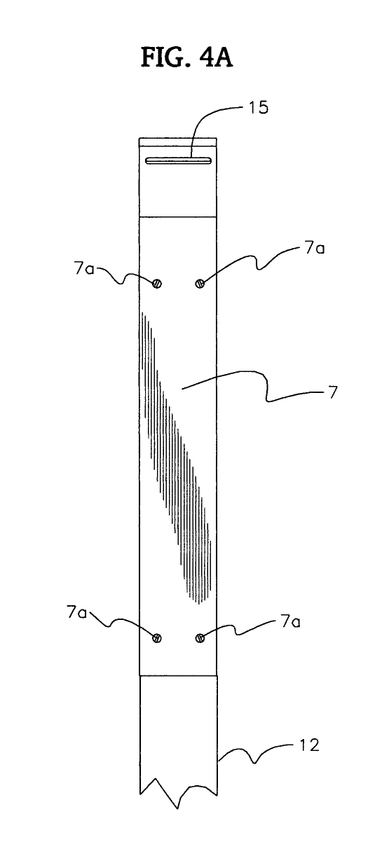

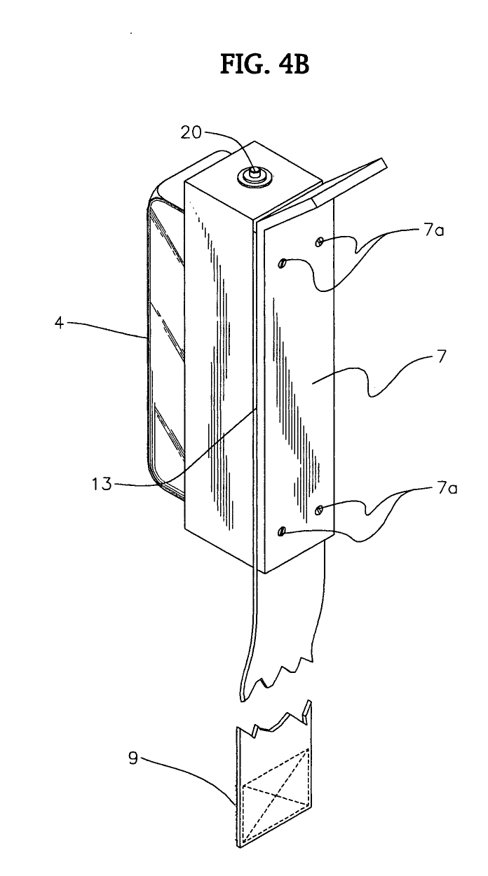

Illumination means 4 (FIG. 4) may be an array of light emitting diodes (LEDs) which flash in a predetermined sequence or burn or flash as an array of selected colors. Such arrays are available in the prior art and provide a new and useful application for such embodiments as the present invention. The LEDs may be of varying colors, red, amber, white or other variations, in combination or singularly displayed. The same principles apply to light emitting means 14 and light emitting means 16 (FIG. 6 and FIG. 7). Light emitting means 14 and light emitting means 16 are bidirectional in that the light is directed in exact opposite directions from the sign by each illumination means. In the schematic disclosed in FIG. 7, lighting means 14 and lighting means 16 may be light emitting diode array 4 and light emitting diode array 6 as disclosed in FIG. 11.

FIG. 11 discloses an alternative embodiment wherein light means 4 is particularly adapted to use an array of light emitting diodes 4a. An array of light emitting diodes 4a are selectively illuminated by controller 4b to cause the light emitting diodes 4a to sequentially flash, strobe in unison or just be illuminated “burn” in unison. The particular manner in which light emitting diodes 4a illuminate is selectively determined by controller 4b.

FIG. 11 further discloses an alternative embodiment wherein light means 6 is particularly adapted to use an array of light emitting diodes 6a. An array of light emitting diodes 6a are selectively illuminated by controller 6b to cause the light emitting diodes 6a to sequentially flash, strobe in unison or just be illuminated “burn” in unison. The particular manner in which light emitting diodes 6a illuminate is selectively determined by controller 6b.

Controller 4b and controller 6b are responsive to receiving rapid pulses of power to cause the programming of controller 4b and controller 6b to respond to cause lighting means 4 and lighting means 6 to flash, sequence or be continuously lighted.

Lighting means 14 and lighting means 16 disclosed in FIG. 6 may also be light emitting diodes as disclosed in FIG. 11 instead of incandescent or other lighting bulbs commonly known in the art. Lighting means 80 on traffic cone 82 may be light emitting diodes as disclosed in FIG. 11.

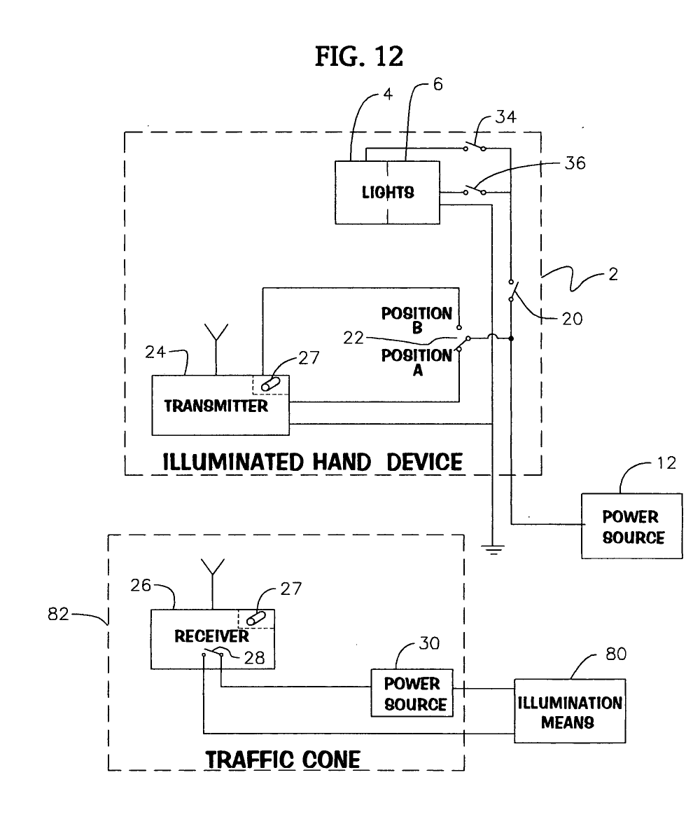

FIG. 8 discloses a further embodiment of a remote control device such as is disclosed in FIG. 6. Many traffic control situations such as school crossings utilize a cone usually orange in color. While the selected color attracts the attention of pedestrians and motorists, the recognition factor may be improved by positioning an illumination means 80 on top of cone 82. Illumination means 80 may be illuminated during certain times as when school children are leaving school. Alternatively, lighting means 80 may be remotely controlled by hand device 2 by way of the circuitry disclosed in FIG. 12. In this manner, lighting means 80 is selectively energized as determined by the user of hand device 2. When hand device 2 is positioned in a predetermined posture, transmitter 24 (FIG. 12) will cause a signal to be transmitted to receiver 26 to thus cause illumination means 80 (FIG. 8 and FIG. 12) to be energized.

As further disclosed in FIG. 12, a manually responsive switch 34 may be positioned between positional sensitive switch 20 and lighting means 4 to totally disable lighting mens 4 from being energized regardless of the position of positional sensitive switch 20. Yet another manually responsive switch 36 may be positioned between positional sensitive switch 20 and lighting means 6 to totally disable lighting means 6 from being energized regardless of the position of positional sensitive switch 20. Switch 34 and switch 36 may be ganged together or be part of a single switch or be independent of each other. Thus, the hand device may be designed to permit the user of the hand device 2 to individually select to have one or two lights in use or only a single source of light. While this particular embodiment is disclosed to have one or two light emitting means, the hand device may have additional lighting means.

Illumination means 80 is further disclosed in FIG. 8 to disclose lighting means 84a on side 84 of illumination means 80, lighting means 86a on side 86 of illumination means 80, lighting means 88a on side 88 of illumination means 80, lighting means 90a on side 90 of illumination means 80 and lighting means 92a on side 92 of lighting means 80. While it is disclosed that a lighting means is disposed on each side of illumination means 80 except for the bottom side, it is not necessary that each side of illumination means 80 be illuminated as only one selected side may be lighted as determined by the environment of use. Each side 84, 86, 88, 90 and 92 of illumination means 80 may be identical as shown in the side view disclosed in FIG. 10.

Illumination means 80 may be an array or light emitting diodes. For example, lighting means 84a may an array of light emitting diodes and associated controller as is lighting means 4 and lighting means 6 disclosed in FIG. 11. Thus, each lighting emitting diode array may be caused to pulsate or burn in a predetermined manner. Each side of illumination means 80 may be comprises of selected lighting means. Lighting means 84 a and lighting means 86a and lighting means 88a and lighting means 90a and lighting means 92a may be identical or may be of different colors and/or types of lighting means such as incandescent or light emitting diodes or other lighting means available in the prior art. Each such lighting means may have circuitry such as lighting means 4 of hand device 2 as disclosed in FIG. 11.

While the above description contains many specifics, these should not be construed as limitations on the scope of the intention, but rather as exemplifications of one or another preferred embodiments thereof. Many other variations are possible, which would be obvious to one skilled in the art. Accordingly, the scope of the invention should be determined by the scope of the appended claims and their equivalents, and not just by the embodiments.

It is therefore understood that while certain forms of this invention have been illustrated and described, it is not limited thereto except insofar as such limitations are included in the following claims and allowable functional equivalents thereof.

1. An illuminated hand device comprising:
a. an illumination means comprising at least one lighting means;
b. a power source;
c. a first positionally sensitive switching means for selectively connecting said power source means to said illumination means,
d. means for securing said illuminated hand device around the hand of the user thereof whereby said lighting means is over the hand of the user thereof;
wherein said positionally sensitive switching means causes said illumination means to be energized when said illuminated hand device is in a first predetermined position and de-energized when said illuminated hand device is in a second predetermined position.

2. An illuminated hand device as set forth in claim 1 wherein said illuminated hand device has a vertical axis which is aligned across the hand of the user from the thumb to the side of the hand of the user when said illuminated hand device is secured to the hand of the user and a longitudinal axis which is aligned across the palm of hand of the user in general longitudinal alignment with the fingers of the hand of the use.

3. An illuminated hand device as set forth in claim 2 wherein said first positionally sensitive switching means for selectively connecting a power source means to said illumination means comprises a switch which is closed when the said longitudinal axis of said illuminated hand device is in a substantially horizontal position.

4. An illuminated hand device as set forth in claim 2 wherein said positionally sensitive switching means for selectively connecting a power source means to said illumination means comprises a switch which is closed when the said vertical axis of said illuminated hand device is in a substantially horizontal position.

5. An illuminated hand device as set forth in claim 1 wherein said illumination means comprising at least one lighting means comprising an array of light emitting diodes, said array comprising a control means for selectively determining the flashing sequence of said light emitting diodes.

6. An illuminated hand device as set forth in claim 1 wherein said illumination means comprising at least one lighting means comprising an array of light emitting diodes, said array comprising a control means for selectively determining the flashing intensity of said light emitting diodes.

7. An illuminated hand device as set forth in claim 4 wherein said illumination means comprising at least one lighting means positioned for directing light in a direction away from the palm of the hand of the user.

8. An illuminated hand device as set forth in claim 1 in combination with a remote illumination device, said remote illumination device comprising:
1. an illumination means;
2. a receiver; and
3. a power source, and
wherein said illuminated hand device further comprises:
d. a transmitter and
e. a second positionally responsive switching means;
whereby said transmitter is caused to emit a first signal when said second positionally responsive switch of said hand device is in a first predetermined position, said first signal being received by said receiver to cause said illumination means of said remote illumination device to be energized, and whereby said transmitter is caused to emit a second signal when said second positionally switch of said hand device is in a second predetermined position, said second signal being received by said receiver to cause said illumination means of said remote illumination device to be de-energized when said hand device is in a second predetermined position.

9. An illuminated hand device as set forth in claim 1 to further comprise a controller electrically connected between said power source and said lighting means wherein said controller causes said lighting means to be activated as selectively determined by said controller.

10. An illuminated hand device as set forth in claim 1 to further comprise:
1. a second positionally sensitive switching means and
2. a transmitter,
said second positionally sensitive switching means comprising:
a first position being electrically connected between said power source and said transmitter whereby said transmitter is caused to transmit a first signal when said second positionally sensitive switching means is in a first predetermined position,
in combination with a remote illumination device, said remote illumination device comprising:
a. a receiver having a switching means,
b. a power source and
c. illumination means
wherein said receiver receives said signal transmitted by said transmitter of said illumination hand device to cause said switching means of said receiver to cause said power source of said remote illumination device to be electrically connected to said illumination means of said remote illumination device to cause said remote illumination means to be illuminated.

11. An illuminated hand device as set forth in claim 10 wherein said second positionally sensitive switching means comprises a second position being electrically connected between said power source and said transmitter when said illumination hand device is in a second predetermined position whereby said transmitter is caused to transmit a second signal when said second positionally sensitive switching means is in a second predetermined position, said second signal being received by said receiver to cause said switching means of said receiver to disconnect said power source of said remote illumination device from said illumination means of said remote illumination device whereby said remote illumination device is extinguished

12. An illuminated hand device in combination with a remote illumination device as set forth in claim 9 wherein said remote illumination device further comprises a controller for selectively causing said illumination means of said remote illumination device to be energized in a selected sequence.

13. A hand device as set forth in claim 12 wherein said illumination means of said remote illumination device comprise light emitting diodes.

14. An illuminated hand device as set forth in claim 10 wherein said remote illumination device further comprises a traffic cone having a top and a bottom and wherein said remote illumination device is mounted on the top of said traffic cone.

15. An illuminated hand device as set forth in claim 1 wherein said lighting means comprises an array of light emitting diodes and said illumination means further comprises a controller whereby said light emitting diodes are energized in a desired configuration as determined by said controller.

16. An illuminated hand device comprising:
a. an illumination means comprising at least one lighting means, said illumination means having a top side, a first side and a bottom side;
b. a first positionally sensitive switching means;
c. a substrate having a length substantially the width of a human hand, a first end and a second end, said substrate being configured to conform to said bottom of said illumination means and having a flange on said first end, said flange being angled away from said bottom of said illumination means and having an aperture there through;
d. a strap having a first end and a second end; and
e. a securing means for securing said first end of said strap to said first end of said substrate;
wherein said second end of said strap is of sufficient length to pass around the hand of the user thereof and pass through said aperture to thus secure said illuminated hand device to the hand of the user thereof.

17. An illuminated hand device as set forth in claim 16 wherein said bottom of said substrate has a plurality of screw holes there into and wherein said substrate has a plurality of opening there through and wherein said first end of said strap has a plurality of openings there through, said securing means comprises a plurality of screws which pass through said holes of said substrate, through said opening in said first end of said strap and into said screw holes in said bottom of said substrate,
whereby said first end of said strap is thus secured to said substrate.

18. An illuminated hand device as set forth in claim 17 wherein said second end of said strap further comprises a top side and a bottom side, said top side being positioned adjacent said bottom of said illumination device when secured to said bottom side of said illumination device and wherein said top side of said strap at said second end of said strap comprises a Velcro® portion thereof of sufficient length to pass through said aperture and fold back against said top side of said second end of said strap to mate with said Velcro® portion of said top side of said second end of said strap in a securing relationship.

19. An illuminated hand device as set forth in claim 1 to further comprise:
a substrate having a length substantially the width of a human hand, a first end and a second end, said substrate being configured to conform to said bottom of said illumination means and having a flange on said first end, said flange being angled away from said bottom of said illumination means and having an aperture there through;
wherein said strap comprises a first end and a second end; and
wherein said second end of said strap is of sufficient length to pass around the hand of the user thereof and pass through said aperture to thus secure said illuminated hand device to the hand of the user thereof.

20. An illuminated hand device as set forth in claim 1 wherein said illumination means comprises a top side, a first side and a bottom side,
a substrate having a length substantially the width of a human hand, a first end and a second end, said substrate being configured to conform to said bottom of said illumination means and having a flange on said first end, said flange being angled away from said bottom of said illumination means and having an aperture there through;
a strap having a first end and a second end; and
a securing means for securing said first end of said strap to said first end of said substrate;
wherein said second end of said strap is of sufficient length to pass around the hand of the user thereof and pass through said aperture to thus secure said illuminated hand device to the hand of the user thereof.

21. An illuminated hand device as set forth in claim 20 wherein said bottom of said substrate has a plurality of screw holes there into and wherein said substrate has a plurality of opening there through and wherein said first end of said strap has a plurality of openings there through, said securing means comprises a plurality of screws which pass through said holes of said substrate, through said opening in said first end of said strap and into said screw holes in said bottom of said substrate,
whereby said first end of said strap is thus secured to said substrate.

22. An illuminated hand device as set forth in claim 21 wherein said second end of said strap further comprises a top side and a bottom side, said top side being positioned adjacent said bottom of said illumination device when secured to said bottom side of said illumination device and wherein said top side of said strap at said second end of said strap comprises a Velcro® portion thereof of sufficient length to pass through said aperture and fold back against said top side of said second end of said strap to mate with said Velcro® portion of said top side of said second end of said strap in a securing relationship.
